(19) United States
(12) Patent Application Publication
(10) Pub. No.: US 2011/0044178 A1
(43) Pub. Date: Feb. 24, 2011

(54) METHOD FOR IMPLEMENTING WIRELESS TELECOMMUNICATION NETWORKS

(75) Inventors: Kimmo Oinonen, Veikkola (FI); Krzysztof Marcisz, Helsinki (FI); Mika Laurila, Roykka (FI); Pasi Viertola, Espoo (FI)

Correspondence Address: BROOKS KUSHMAN P.C., 1000 TOWN CENTER, TWENTY-SECOND FLOOR, SOUTHFIELD, MI, 48075, US

(73) Assignee: EUROPEAN COMMUNICATIONS ENGINEERING OY, Espoo (FI)

(21) Appl. No.: 12/867,159

(22) PCT Filed: Feb. 6, 2009
(86) PCT No.: PCT/FI09/50099

§ 371 Date: Nov. 5, 2010

(30) Foreign Application Priority Data
Feb. 11, 2008 (FI) 20080093

(51) Int. Cl. H04W 16/18; H04L 12/24

(52) U.S. Cl. 370/241; 455/456.1; 455/446; 370/328

(57) ABSTRACT

A method for planning a radio network, the method comprising determining for the components and parameters of the radio network an association with a location and a time. In a preferred embodiment, said association with a location is determined on the basis of geographical location and/or logical location. In planning the radio network, information on the association is utilized to improve quality of service of the radio network and to facilitate the work of the planning engineer.

### FIELD OF THE INVENTION

The present invention relates to a method for planning and implementing wireless telecommunication networks.

### BACKGROUND OF THE INVENTION

Wireless telecommunication networks include for example mobile telephone networks (GSM/IS-95/UMTS/CDMA2000/TETRA), new broadband networks such as WiMAX or local area networks such as WLAN, and so-called broadcasting networks such as television broadcast and DVB-H, and other networks in which terminals communicate wirelessly with base stations. Wireless telecommunication networks comprise a core network and a radio network. Radio networks must be planned in order for the user to be able to receive the signal with sufficiently high quality. Strength and quality of the signal are important planning criteria together with network capacity. The network capacity refers to the performance of the network, i.e. how many users are able to use the services of the radio network at the same time. The objective in planning is therefore to provide a network which satisfies the users' needs as well as possible with sufficient coverage and adequate capacity.

Currently radio networks are being planned using so-called planning software to first calculate the signal range from different base station sites. The planning software is then used to calculate interference between base stations which affects the performance of the radio network. In addition, one typical type of calculation encompasses for example estimating the capacities. At the end of the planning process, one important function of the planning systems is to operate as documentation environment which comprises the devices of the radio network, i.e. the so-called network elements.

In addition to planning software, different kinds of measuring equipment, such as field measuring devices, a radio network control system, and different kinds of software for comparing the planning and measurement results and presenting and visualizing them in other ways are used in radio network planning. These functions are generally referred to as optimization with the objective of finding e.g. possible planning and mounting faults in the radio network. Another purpose of optimization is to find solutions to the discovered problems. Typically, special software is available for optimization, but the most practical solution is to integrate the planning and optimization software to form one unity.

In planning radio networks, the key task is to create a configuration and topology for the radio network, which means locating the network elements, i.e. associating them with a location or a position and also with a time. For example the base station site, the base station equipment including the antenna line, and other parameters are taken into account in the locating process.

The planning engineer may create a radio network plan which is completely separate from all other radio network plans. In real applications, however, radio network plans are mostly such that they depend on each other on a time line. Also the position of the elements included in the plans in relation to each other affects the dependency. In other words, the plans are interdependent in terms of time and position. Positional dependency may be of a physical or logical kind. Physical positional dependency, i.e. location-related dependency, means that the network elements are physically and/or geographically so close to each other that changes effected upon them may affect another element close by. Logical positional dependency, on the other hand, means that some elements of the radio network system are interdependent despite their physical distance, and in this instance, too, changes effected upon one of them call for measures in the other.

In addition to these dependencies, one problem is caused by the simultaneous planning work of many different planning engineers, which provides problems in particular when the time-location-relations are close to each other. The method described herein provides a solution for managing a complex planning environment.

### SUMMARY OF THE INVENTION

The present invention describes a method for planning a radio network. The method according to the invention comprises determining for the components and the parameters of the radio network an association with a location and a time. In one preferred embodiment of the invention, said association with a location is determined on the basis of geographical location and/or logical location. Further in one embodiment of the invention, said association with a time is determined on the basis of a time line. The above-mentioned embodiments may be realized separately or together, in which case said association is determined by the location and the time both. Said time line may be managed by a calendar or a clock. Accuracy of the time unit may be selected in each case according to need, for example with an accuracy of an hour or a day.

Further in one preferred embodiment of the invention, all components of the radio network are associated with the time line as separate or related operations. In one embodiment of the invention, users are informed of the operations managed by the time line.

The present invention is most preferably implemented as computer software in a system including planning equipment and a wireless telecommunication network with base stations.

FIG. 1 presents a typical situation where the network parameters are being changed. The figure comprises five base stations and the corresponding coverage areas 10 to 14. At the point of contact of coverage areas 11 and 12 of the base stations, the coverage areas meet only barely. This may affect that particular coverage area and at that particular point of contact coverage of the network is only acceptable. The signal range may be considerably weakened for example due to weather conditions and, in that case, a shadow area may emerge between the coverage areas. Correspondingly, the coverage area may change for example because a new and large building is constructed in the area. This problem may be solved by adjusting the network, for example the coverage area 11 of the base station indicated in dash line so as to enlarge it. The coverage areas of the base stations may therefore vary according to terrain shapes and service standards. For this reason, coverage areas of different sizes as presented in FIG. 1 are realistic and quite typical.

In the present patent application, base station refers to all physical and programmatic components of the base station equipment which can be used to affect the shape and size of the coverage area encompassed by the base station. Examples of such physical components include base station amplifiers, antennas, filters and the like.

In the present patent application planning refers to planning a completely new radio network and to optimizing a radio network in the form of updates and changes performed in the existing networks. Such further planning or optimization is necessary for example in cases where the original plan still includes shadow areas or the number of users in the area has grown to such extent that new base stations are required to their service. Further, it should be understood that in the application, analysis of the radio network, which is necessary for the planning and optimization, falls within the scope of the invention. Therefore, in the present patent application optimization and replanning refer substantially to the same cause.

The present invention facilitates considerably planning and implementation of telecommunication networks. The invention is particularly advantageous in cases where an existing information network is being completed by adding or removing base stations according to the need of meeting the quality of service criteria. Thanks to the present invention, it is possible to plan upcoming changes and assess the whole so as to be able to detect effects of the change on other base stations and the overall coverage area. Further, the present invention facilitates the work of many individual planning engineers within the same telecommunication network because each planner is able to stay informed of the others' work. Further, one advantage of the invention is facilitation of assessment of the changes effected upon the network. If audibility of the network changes contrary to the preliminary plans, for example is reduced in a specific area due to unpredictable interference. The present invention enables locating the changes effected in a specific area over a certain period of time, and for example poor audibility caused by interference or a complete shadow area may be removed by corrective planning.

### LIST OF FIGURES

FIG. 1 illustrates an example of the operating environment of the invention in accordance with the known technology,

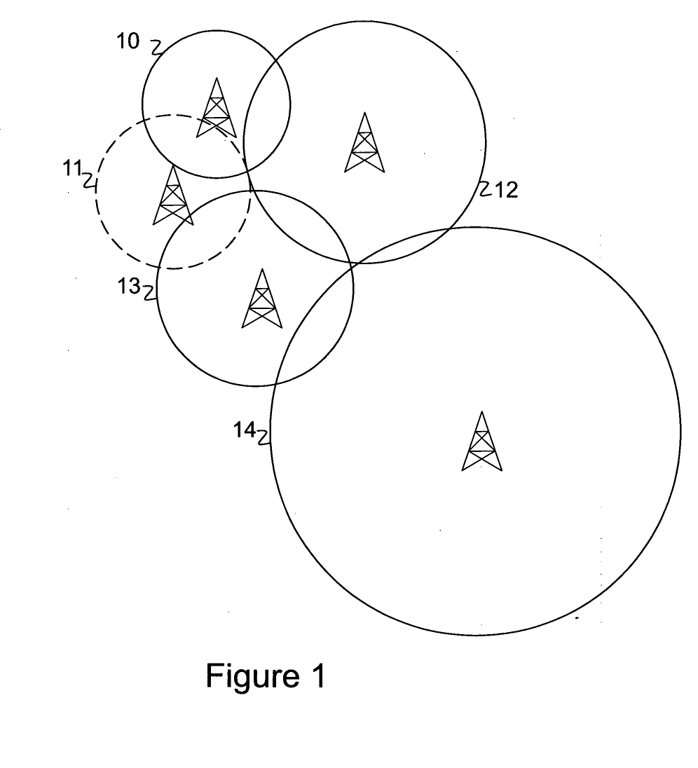

FIG. 2 illustrates an example of a time line according to the invention, and

FIG. 3 illustrates one example of a telecommunication system utilizing the present invention.

### DETAILED DESCRIPTION OF THE INVENTION

Problems caused by time dependency may be solved by organization of the plans which is implemented using a calendar or a time line wherein the past and the realized plans situate behind the present moment and the unrealized upcoming plans situate ahead of the present moment. Each plan is dependent on all previous plans. In other words, the time of implementation set for a plan determines against what kind of cumulatively realized environment generated by the previous plans it has been planned. If the time of implementation set for a plan changes so that the order of the plans on the time line becomes changed, one must check if the plans are also dependent in terms of location and, if that is the case, the plans must be revised and, if required, corrected due to the change effected in the order of implementation.

Logical dependencies may be discovered by mapping the radio network using a planning tool and examining its topology. Location-related dependency, on the other hand, may be realized by many different methods in the radio network plans. The easiest way is to select a suitable distance such that two elements of the network which are closer to each other than that distance can be assumed to be interdependent in terms of location. Another and better method is to examine the real measurable or predictable dependencies between elements of the radio network. By examining measurements from an already built radio network a realization of the dependencies between different elements can be discovered. In the case of a network which is only being planned, or when it is not desirable to use network measurements, it is possible to generate radio coverage prognoses to express the dependencies and control them appropriately. It is also possible to aim at expressing the location-related dependency by examining the parametrization of the radio network. For example, adjacent elements determined for the elements of the network allow one to draw various conclusions on the dependencies on the surrounding elements and on their criticality.

Advantages of the present invention become apparent when the dependencies described above are combined together in such manner that time dependency is combined with logical and/or location associated dependencies, in which case the logical and location associated dependencies are combined with the moment in time when the plan was made or with the moment in time when the change according to the plan is implemented.

If dependencies are found during time and position checks, the tool performs a set of checks and based on them provides information on defects and warnings for the user of the planning tool. In other words, the planning engineer does not always need to known or notice the dependencies or problems they may cause by him/herself. The tool is able to inform the planning engineer in this respect. The tool is also able to perform a number of automatic corrections to solve the problems.

Solution to the simultaneous planning may be provided by the time line. Plans are always located in a row on the time line. Simultaneous plans are not accepted. The times of implementation may, however, differ from each other for example only for one second. This will always provide a determined dependency in relation to the other plans. If a user makes a plan and saves it to be published, it is managed by the warnings, defect reports and automatic corrections generated on the basis of the time and positional dependency checks.

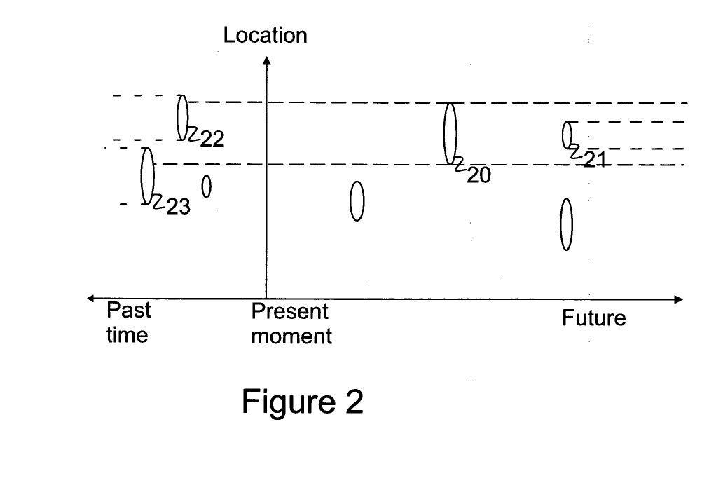

FIG. 2 presents one example of such planning tool focusing on a plan 20. In addition, there are past plans 22 and 23 which have already been implemented, and upcoming plans 21. The figure illustrates in dash line how they affect each other by overlapping. The planning engineer is easily able to judge by the figure which plans have been made previously or intended for future implementation, and to determine how they affect the plan which is being made at that moment.

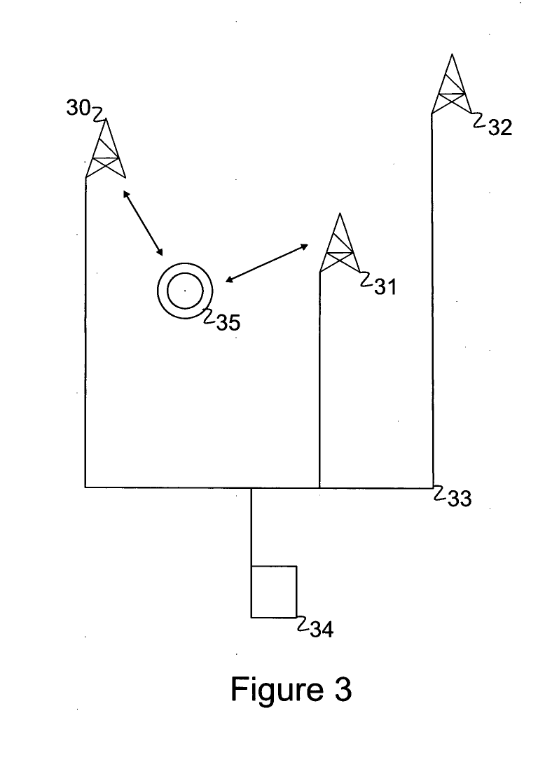

FIG. 3 presents one system according to the invention. The system includes a telecommunication network comprising three base stations 30, 31 and 32 and a core network 33. Further, the system includes a workstation 34 provided with software for entering the parameters of the planning software into the actual 30 telecommunication network. In addition, the workstation software is able to receive, automatically or separately entered, statistical data or measurement results. The planning software run on the workstation 34 applies the method as described above to determine the dependencies between base stations. When the present invention is utilized in the system, the operation of the presented base stations 30, 31 and 32 changes according to the plans, affecting the signal strength and thereby the geographical and logical coverage area. The signal may either strengthen or weaken depending on the situation. Further, new base stations may be introduced in the system, in which the location may affect the already existing base stations and the telecommunication signal produced by them. Also other changes which affect the propagation of the telecommunication signal produced by the network may be effected in the system. In addition to those mentioned above, the changes may encompass other settings known by the person skilled in the art which may be programmatic or changes effected in the existing base station equipment.

In one embodiment of the invention, the system includes measuring equipment 35 which in the example of FIG. 3 is so-called field measuring equipment. Typically, the field measuring equipment comprises for example a mobile telephone provided with suitable properties, a mobile telephone and pc equipment, or a separate measuring device designed for that purpose. In the example of FIG. 3 the measuring equipment 35 measures the coverage area of the radio network produced by base stations 30 and 31. Location of the measuring equipment 35 is known for example by using satellite positioning. Typically, telecommunication networks are provided with systems which collect the equivalent kind of statistical data, but the problem is that a sufficiently accurate location of the measured users cannot be determined. In future, location-related information is transmitted from terminals provided with satellite positioning means to a statistics collecting system. The above-mentioned statistical data or the measurement data collected by the measuring equipment 35 is transferred to the workstation 34 in which the data can be analyzed and used to facilitate planning and optimization.

Plans, optimizations and changes performed by the workstation 34 are entered in the telecommunication network in the manner available in each particular network. The network may comprise a centralized control system or they can also be entered directly in said base stations. In many cases, changes which require visits by the technician on the spot to implement them are also made in the base station. One example of such change is rotating the antenna.

The invention is not limited merely to the exemplifying embodiments referred to above; instead, many variations are possible within the scope of the inventive idea defined by the claims.

1. A method, comprising determining an association with a location and a time for the components and parameters of a radio network.

2. The method according to claim 1, wherein the method further comprises the steps of:
measuring the properties of the radio network;
determining an association with a location and a time for the acquired measurement results.

3. The method according to claim 1, wherein said association with a location is determined on the basis of geographical location and/or logical location.

4. The method according to claim 1, wherein said association with a time is determined on the basis of a time line.

5. The method according to claim 4, wherein said time line is managed by a clock and a calendar.

6. The method according to claim 4, wherein the time line is managed with the accuracy of a predetermined time unit.

7. The method according to claim 4, wherein all components of the radio network are associated with the time line as separate or related operations.

8. The method according to claim 4, wherein users are informed of the operations managed by the time line.

9. The method according to claim 1, wherein said method is used in a radio network for at least one of the following: planning, measuring, optimization and analysis.

10. A computer program for planning a radio network, stored on a storage medium which is readable by data processing means, wherein when executed in a data processing equipment said computer program is arranged to perform the method according to claim 1.

11. A system comprising:
a wireless telecommunication network comprising a number of base stations, each of the base stations covering different geographical areas and forming together a continuous audibility range; and
a workstation including general data processing means comprising a processor, memory, mass memory and a bus;
wherein said workstation is arranged to execute the computer program according to claim 10 by the processor.

12. The system according to claim 11, wherein the system further comprises a measuring equipment arranged to provide measurement results to said workstation.
